(19) United States
(12) Patent Application Publication
(10) Pub. No.: US 2015/0115626 A1
(43) Pub. Date: Apr. 30, 2015

(54) LOCK FOR A FLAP OR DOOR

(71) Applicant: Kiekert Aktiengesellschaft, Heiligenhaus (DE)

(72) Inventors: Thorsten Bendel, Oberhausen (DE); Armin Handke, Duisburg (DE); Michael Herrmann, Neukirchen-Vluyn (DE); Matthais Ochtrop, Dorsten (DE)

(21) Appl. No.: 14/398,750

(22) PCT Filed: May 2, 2013
(86) PCT No.: PCT/DE2013/000245

§ 371 Date: Nov. 4, 2014

(30) Foreign Application Priority Data
May 4, 2012 (DE) 10 2012 207 442.2

(51) Int. Cl. E05B 85/20

(52) U.S. Cl. CPC E05B 85/20
USPC 292/195

(57) ABSTRACT

The aim of the invention is to design a door lock or flap lock which can be easily and reliably opened with little effort. Said aim is achieved by a door lock or flap lock comprising a locking mechanism that consists of a rotary latch and at least one pawl for locking the rotary latch, the design of the rotary latch and the pawl being such that the rotary latch can initiate a torque in the pawl, in particular an opening moment. The torque is dependent on the detent position of the pawl.

The invention relates to a lock for a flap or a door with the characteristics of the generic part of claim 1. A lock of said design is disclosed in publication DE 10 2008 061 524 A1. The door or flap can be a door or flap of a motor vehicle or of a building.

The aforementioned lock comprises a locking mechanism that contains a rotary latch and at least one pawl with which the rotary latch can be locked in a closed position. In the closed position the rotary latch can keep a door or flap closed, so that the door or flap cannot be opened. If the rotary latch is in an open position, the locking bolt can leave the locking mechanism and the door and flap can be opened.

Publication DE 10 2010 003 483 A1 discloses a locking mechanism, in which the rotary latch initiates an opening moment in the pawl when the pawl latches the rotary latch in the main tappet position. The rotary latch can for instance initiate such a moment in the pawl as a result of a door sealing pressure and/or due to a pretensioned spring that can turn the rotary latch into its opening position and/or opening of a respective door or flap. The pawl can be moved out of its locked position into its detent position by an opening moment. In order to reliably prevent this in the event of a locked locking mechanism, the arrangement also contains a blocking lever that can block the movement of the pawl out of its detent position. To open such a locking mechanism, the blocking lever is moved out of its blocking position with the aid of the release lever. Generally the opening moment initiated by the rotary latch in the pawl suffices to unlock the locking mechanism, i.e. to open it.

A lock of the type described above generally contains a release lever with which a locked locking mechanism can be opened or unlocked. Actuation of the release lever causes the pawl to leave or to be able to leave its locking position for opening of the locking mechanism.

In a locking mechanism with the aforementioned opening moment it can happen for a variety of reasons that the moment does not suffice to move the pawl out of its locking position. In order to ensure that the locking mechanism opens also in the event of such a malfunction, a tappet is provided that is, for instance attached to the release lever and/or the intermediate closed position pawl disclosed in DE 10 2010 003 483 A1. Such a tappet should move the pawl out of its locking position in particular if the pawl is unable to leave the locking position solely as a result of the opening moment.

In order for the tappet to be able to open the locking mechanism, it must be possible to pivot the tappet arranged, for instance, on the release lever by a sufficiently large angle. In general, an angle of between 20° to 30° suffices, such as approx. 25°, for the pawl to be moved out of its locking position solely by means of the tappet.

A release lever of a locking mechanism is generally moved by actuation of a handle. The handle can be an internal door handle or an external door handle of a motor vehicle. Such a handle is generally connected to the release lever via a rod assembly or a Bowden cable in order to move the release lever upon actuation of the handle. Signs of wear and/or tolerances on the rod assembly or on the Bowden cable can reduce or decrease the pivot angle of the release lever actuated by the handle.

The aim of the invention is to provide a reliably working lock of the type described above.

The aim of the invention is achieved by a lock with the characteristics of the first claim. Advantageous embodiments are disclosed in the sub claims.

In order to solve this task, a lock for a door or flap comprising a locking mechanism consisting of a rotary latch and at least one pawl is provided for locking the rotary latch. The design of the rotary latch and pawl is such that the rotary latch can initiate a torque in the pawl and, in particular an opening moment. In one embodiment, the rotary latch can also initiate a closing moment in the pawl in a detent position of the locking mechanisms in order to also provide particularly reliable locking where no blocking lever is present. In case of a closing moment, a force is initiated in the pawl that can move the pawl in the direction of the detent position. The locking mechanism can then be reliably locked without the provision of a blocking lever. In this case a relatively great amount of force is, however, required to move the pawl out of its detent position in order to open the locking mechanism. The force is amongst other things required because of the frictional resistance between the rotary latch and pawl and increases with an increasing frictional resistance between rotary latch and pawl. The frictional resistance can, for instance, be increased by impurities, such as sand.

The torque initiated in the pawl depends in the invention on the detent position of the pawl, i.e. on a position of the pawl in which it prevents the rotary latch from being moved back into the open position. There are thus two different and in particular, two differently dimensioned torques which the rotary latch can initiate in the pawl depending on the detent position of the pawl. As a result of the object of claim 1 a moment can be initiated in the pawl depending on the requirement. The requirement for a torque initiated in the pawl regularly depends on the respective detent position. In this way a particularly reliably functioning lock can be provided.

One embodiment of the invention first of all provides, in particular, an opening moment initiated by the rotary latch in the pawl when the pawl is fully in its detent position. The pawl is fully in its detent position when the locking mechanism is correctly locked for closing a door or a flap. Starting from an unlocked position, the pawl can in particular not or only slightly (overtravel) be moved past the detent position, as it is, for instance, prevented from doing so by a stop. If the pawl is moved in the opposite direction partially out of this detent position, the torque changes. In this case either a greater moment or a greater opening moment is applied for the first time. The pawl is then first moved partially out of its complete detent position when the locking mechanism is opened. As a result of, in particular, a greater moment being finally initiated in the pawl starting from an opening moment, opening is facilitated.

One embodiment of the invention contains at least two differently dimensioned opening moments that can be initiated in the pawl by the rotary latch. If the pawl is completely in its detent position, initially a comparatively small opening first moment is initiated in the pawl by the rotary latch. If the pawl has already been moved partially but not fully out of its detent position, a greater opening second torque is initiated in the pawl by the rotary latch. Due to the greater torque applied in this embodiment, the pawl is also reliably moved out of its detent position when a tappet for the pawl can, for a particular reason, not be pivoted sufficiently to move the pawl fully out of its detent position. This embodiment also contains a blocking lever that can or blocks the pawl when it is fully in its detent position and in particular in its main detent position.

In one embodiment, a pivot angle of the release lever of 15° suffices in order to be able to ensure a reliable unlocking of the locking mechanism. Preferably a pivot angle of 13° suffices for this purpose.

In one embodiment the lock also contains a release lever with which the locked locking mechanism can be released by moving the release lever, in particular by pivoting the release lever. If the release lever is pivoted for opening the locking mechanism, a first small torque is initially initiated in the pawl by the rotary latch. If the release lever has not been pivoted by the maximum possible distance, a second opening torque, which is greater than the first torque, is then initiated in the pawl. This second opening torque is preferably initiated in the pawl by the rotary latch before the release lever has been moved by more than 70% and preferably by more than 50% of its intended pivoting movement. If the release lever is, for instance, designed to be pivoted by 25° in order to open the locking mechanism, the second greater torque is initiated at the latest once the pawl has been moved by 17.5°, i.e. by 70%. Preferably the second greater torque is initiated in the pawl before the release lever has been pivoted by 12.5°, i.e. by 50%. This embodiment creates a buffer for opening the locking mechanism.

Where, for instance for age reasons (wear, tolerances), the release lever can no longer be moved the whole distance, the second greater torque ensures that the locking mechanism can still be reliably opened if the release lever can only be still pivoted 70% or 50% of the distance.

The aforementioned embodiment includes, in particular, a tappet able to move the pawl out of its detent position. In particular, this tappet only moves the pawl at least partially out of its locking position if the pawl is not moved out of its locking position as a result of the initiated opening moment. The tappet ensures that at least initially the pawl is moved out of its detent position by the tappet if the opening mechanism fails due to the initiated first torque. Where the pawl is partially moved out of its locking position by the tappet, a greater opening moment is then initiated in the pawl. The dimension of the opening moment is preferably such that the pawl leaves its locking position also without assistance of the tappet. In this way the locking mechanism can also be reliably opened when, for whatever reason, a release lever can no longer be pivoted over the entire distance. Even if a release lever can be pivoted over the entire distance, the embodiment achieves that a tappet only has to move a pawl partially out of its detent position to open the locking mechanism. The force required for opening such a locking mechanism, is thus also advantageously reduced in case of such malfunctioning.

In order to achieve an even more compact design with fewer parts, the pawl and release lever of the locking mechanism are in one embodiment rotatably mounted on a common axis.

Preferably, the rotary latch is pretensioned by a spring in the direction of the opening position of the lock, in order to be able to initiate a moment in the pawl even without the presence of a door sealing pressure.

In one embodiment of the invention the release lever can move a blocking lever of the locking mechanism out of its blocking position. For this purpose, generally a relatively low force suffices. Where the pawl is subsequently moved out of its detent position by an opening moment initiated in the pawl by the rotary latch, the overall force required for opening the locking mechanism is advantageously very low.

One embodiment provides a spring for moving the blocking lever into its blocking position. The blocking lever can thus be simply and reliably moved into its blocking position by the spring. In one embodiment the blocking lever and pawl are designed in such a way that by moving the blocking lever in its blocking position the pawl is also moved into its detent position. The number of required parts is thus reduced further. At the same time both the weight and required space are also reduced.

In one embodiment, the release lever contains three lever arms. Using a first lever arm, a blocking lever is, in particular, moved out of its blocking position for unlocking the locking mechanism. A second lever arm of the release lever preferably releases the pawl in the described manner, i.e. the spring force able to move the pawl in the direction of the locking position is at least reduced during opening of the locking mechanism. Preferably, this second lever arm contains a tappet for moving the pawl out of its locked position, providing a compact and simply to produce design. The third lever arm is used for activating the release lever i.e. for instance with the aid of a rod arrangement or Bowden cable and preferably with the aid of a connected handle or an electric drive. If the handle is actuated or the electric drive is started, this also actuates the third lever arm and the release lever for unlocking the locking mechanism and said release lever is, in particular, pivoted around an axis. Advantageously, the invention also provides a stop for the second lever arm in order to minimize the required space and weight and prevent the release lever from being moved past a desired end position.

Preferably, the pawl contains two lever arms with one lever arm locking the rotary latch. A mechanism, such as a pretensioned spring acts on the other lever arm, in order to be able to move the pawl into its detent position with the aid of a mechanism, i.e. a pretensioned spring. This other lever arm of the pawl is optionally engaged by a tappet of the release lever to unlock the locking mechanism and is moved accordingly and is, in particular, pivoted around an axis. Advantageously also a stop is provided for this lever arm in order to prevent the pawl from being moved past its full detent position.

A blocking lever for blocking the pawl in its detent position includes preferably two lever arms. A first lever arm of the blocking lever can, in particular, block the pawl in its latched position and/or move the pawl into its latched position. In one embodiment in particular this first lever arm can also be advantageously engaged by the release lever and moved out of its blocking position by pivoting, in particular, around an axis. The second lever arm of the blocking lever can preferably be moved against a stop so that the blocking lever can be moved past a provided end position. The provision of a second lever arm also advantageously contributes to the centre of gravity of the blocking lever being moved in the direction of the axis around which the blocking lever can be pivoted. This movement of the centre of gravity facilitates pivoting of the blocking lever.

In one embodiment, the blocking lever can also function as the release lever in order to minimize the number of components. In one embodiment the release lever also functions as an intermediate closed position pawl that can lock the rotary latch in the intermediate closed position. The locking mechanism can then lock a door or flap. It is, however, not as yet locked as planned in the fully closed position. Starting from the intermediate locked position, the fully closed position is only reached if the rotary latch is pivoted further in the direction of the locked position.

A locking mechanism of the invention is in particular arranged on a metal lock plate or on a lock casing generally made of metal. Usually such a lock also contains a lock housing, generally made of plastic and which can protect components of the lock against external influences. The arrangement can also contain a lock cover made, in particular, from plastic and/or, in particular, a plastic cover for a central locking also provided for protection. The lock can, for instance, be part of a door or flap of a building or of the door or a flap of a motor vehicle.

The invention also includes such a lock with a pawl for the fully closed position of the rotary latch (also referred to as “fully closed position pawl” and a pawl for the intermediate closed position of the rotary latch (also referred to as “intermediate closed position”) and advantageously also a blocking lever for said fully closed position pawl. Such a lock is disclosed in publication DE 10 2008 061 524 A1. A lock of the invention can in addition to the blocking lever, also include only one pawl for locking the rotary latch in an intermediate locked position and a fully closed position.

The rotary latch contains a fork-shaped inlet slot (infeed section), entered by a locking bolt of a door or flap when the vehicle door or flap is closed. The locking bolt then pivots the rotary latch from an opening position into a detent position. Once in the detent position, the locking bolt can no longer move out of the rotary latch. The pawl locks the rotary latch in the detent position so that it cannot be turned back into the open position.

A lock according to the invention contains components such as pawl, blocking lever or rotary latch that can and should be pivoted. Such arrangements regularly contain at least one pretensioned spring, in particular a leg spring, used for producing the desired pivoting movement of such a component as a result of the force of the spring. Such a pretensioned spring can, for instance, move a pawl into its detent position, a blocking lever into its blocking position or a rotary latch into its open position.

The figures show the following

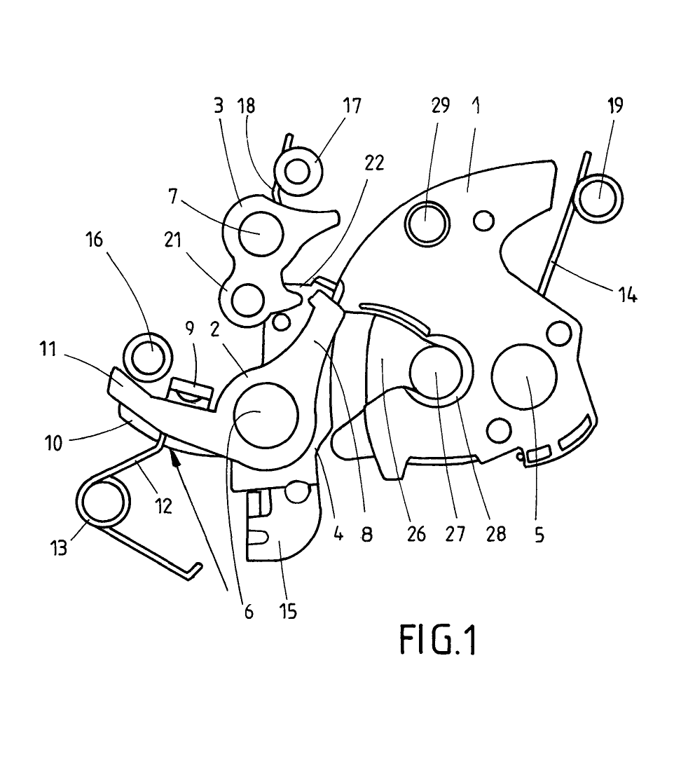

FIG. 1: a locking mechanism at the start of the opening operation;

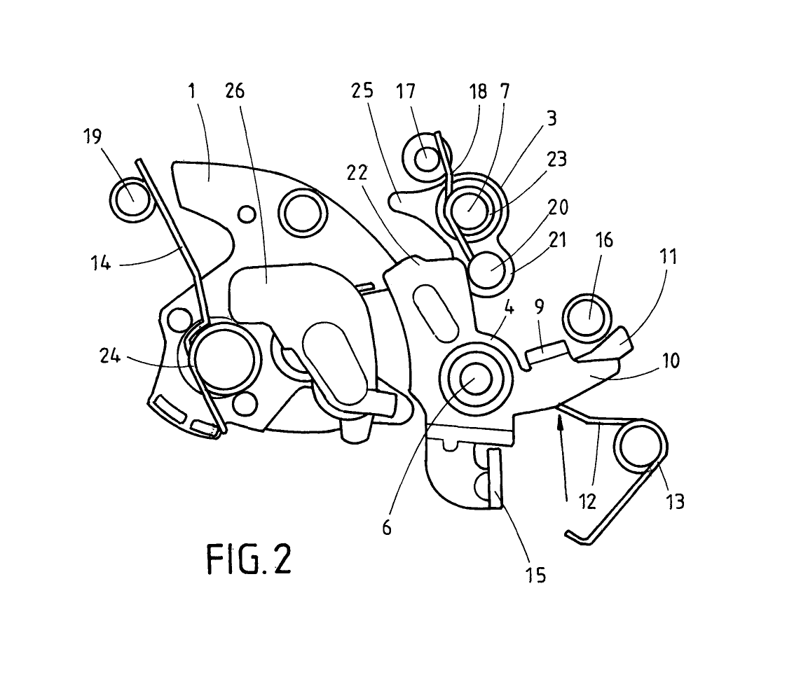

FIG. 2: a rear aspect of a locking mechanism of FIG. 1;

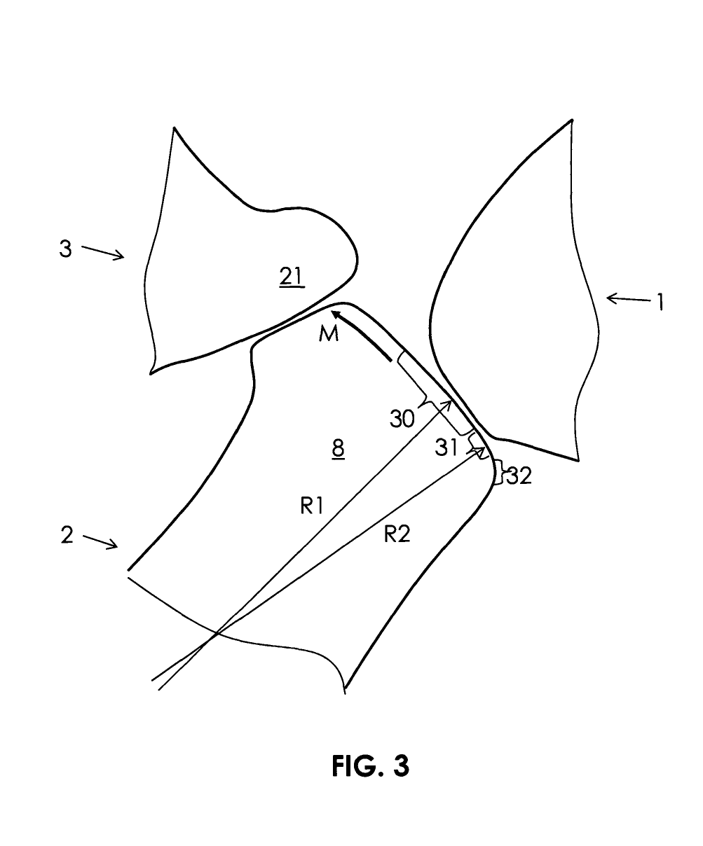

FIG. 3: an enlarged section of locking mechanism.

FIG. 1 shows a locking mechanism comprising a rotary latch 1, a pawl 2, a blocking lever 3 and a release lever 4. The rotary latch 1 can be pivoted around its axis 5. The pawl 2 and the release lever 4 can be pivoted around its common axis 6. The blocking lever 3 can be pivoted around its axis 7.

FIG. 1 shows the start of the opening operation. By pivoting the release lever 4 in counterclockwise direction, the blocking lever 3 has already been moved out of its blocking position. The pawl 2 also locks rotary latch 1 with its lever arm 8. The rotary latch 1, initiating an opening moment in the pawl 2 thus ensures that the pawl 2 is pivoted out of its shown detent position and, in case of FIG. 1, by pivoting around axis 6 in counterclockwise direction. In case of this mechanism failing, the tappet 9, extending upwards from the lever arm 10 of the release lever 4, finally makes contact with the side of the lever arm 11 of the pawl 2 by further pivoting of the release lever 4 in counterclockwise direction moving said pawl also in counterclockwise direction. As a result of this additional mechanism, the lever arm 8 can be at least partially moved out of its detent position where required if this operation as part of the initiation of an adequately high torque into pawl 2 has initially failed. The tappet 9 can thus also serve as an additional unlocking facility between pawl 2 and rotary latch 1, where, for instance dust or wear prevent or hinder unlocking.

In order to be able to initiate an opening moment in the pawl 2 at any time when the pawl is in its detent position shown in FIG. 1, the rotary latch 1 is pushed in the direction of the opening position by a pretensioned leg spring with its spring arm 14 shown in FIG. 1. As a result of the spring, rotary latch can be pivoted around its axis 5 by spring arm 14, shown in FIG. 1 in counterclockwise direction towards its open position.

To activate the release lever 4, i.e. to pivot it in case of FIG. 1 in counterclockwise direction, an actuation of a handle is suitably transferred to the lever 15 of the release lever 4, by means of, for instance a Bowden cable, a rod or a rod mechanism.

A stop 16 limits the pivoting movements of the lever arms 10 and 11 and of the pawl 2 or of the release lever 4 in clockwise direction. The release lever 4 and pawl 2 can consequently not be moved further than a predefined end position. As a result, the pawl 2 can be moved in up to its locking position but not any further. The clockwise pivoting of the release lever 4 is also suitably restricted so that a short actuation travel of a handle suffices to unlock or open the locking mechanism. A stop 17 retains on one hand the spring leg 18 that is part of a leg spring that is able to pivot the blocking lever 3 into its blocking position in counterclockwise direction. The stop 17 restricts the pivoting of blocking lever 3 in counterclockwise direction so that the blocking lever 3 cannot be pivoted further than its blocking position. In particular, the pivoting of the lever arm 25 of the release lever 3 is restricted. A stop 19 retains the spring arm 14 and serves optionally as a stop for the rotary latch 1 in order to suitably restrict a pivoting movement of the rotary latch 1 in clockwise direction, thus restricting overtravel of the rotary latch 1.

FIG. 2 shows a rear view of the locking mechanism of FIG. 1. The figure shows a pin 20, projecting in the direction of the blocking lever arm 21 of the release lever 3 and serving as a tappet for this blocking lever arm 21. Upon activation of the release lever 4 the lever arm 22 finally engages with the respective projecting pin 20 pivoting it and also the blocking lever 3 in such a way that it leaves its blocking position.

In FIGS. 1 and 2 an optional and preferably plastic infeed buffer 26 for the locking bolt 27 is provided in order to prevent creaking noises. A plastic cover of the rotary latch is recessed in a horseshoe-shaped partial area 28 around the locking bolt 27. The rotary latch can contain a protruding pin 29 that can be used to lock the locking mechanisms in the intermediate position, when the locking mechanism includes a intermediate closed pawl on a plane above the pawl 2 shown in FIG. 1.

FIG. 3 shows an enlarged section of rotary latch 1, lever arm 21 of the blocking levers 3 and lever arm 8 of the pawl 2 in the fully closed position. As the lever arm 21 blocks the lever arm 8 of the pawl 2, the pawl 2 is in its fully locked position. The rotary latch 1 rests against a section 30 of the lateral contour of the lever arm 8 of the pawl 2. The radius R1 of this first contour is in particular 18-22 mm, or preferably 20 mm. The rotary latch 1 initiates a first torque in the pawl 2 when the rotary latch 1 rests against the first contour section 30. If the blocking lever 3 is moved out of its blocking position, the pawl 2 initially partly leaves the fully closed position. The rotary latch 1 then rests against a second contour section 31 of lever arm 8 of the pawl 2. The radius R2 of the second contour section 31 is smaller and is, in particular, less than 20 mm. If the rotary latch rests against the second contour section 31, the pawl 2 still prevents the rotary latch 1 from pivoting back to the opening position. A greater opening torque M is then initiated in the pawl 2 by the rotary latch 1. The contour section 31 is followed by a third contour section 32 which is clearly more curved. The third contour section 32 can no longer prevent the rotary latch 1 from moving into the opened position. The position of the contour sections 30 and 31 matches, in particular, the pivoting movement of the release lever 4. If the release lever 4 has been pivoted by 50% and/or by 10 to 15 degrees, such as 13.5 degrees, the rotary latch 1 rests against the contour section 31 in one embodiment or has even moved passed this contour section 31 and can move in the direction of the opening position without restriction.

The torque which can be initiated in a pawl 2 of a locking mechanism by the rotary latch 1 can also continuously change i.e. can, for instance increase continuously.

### REFERENCE LIST

1: Rotary latch
2: Pawl
3: Blocking lever
4: Release lever
5: Pawl axis
6: Common axis of pawl and release lever
7: Blocking lever axis
8: Locking lever arm of pawl
9: Release lever tappet
10: Leave arm of release lever
11: Lever arm of pawl
12: Spring arm
13: Leg spring
14: Spring arm
15: Actuating lever arm of release lever
16: Stop for pawl and release lever
17: Stop for blocking lever
18: Spring arm
19: Stop
20: Pin
21: Blocking lever arm
22: Unlocking lever arm of release lever
23: Leg spring for blocking lever
24: Leg spring for rotary latch
25: Infeed buffer for locking bolt
26: Locking bolt, lock holder
27: Part section without plastic coating
29: Protruding pin of rotary latch
30: First contour area
31: Second contour area
32: Third contour area

1. A lock for a door or flap comprising a locking mechanism that comprises a rotary latch and at least one pawl for locking the rotary latch, in which the rotary latch and the pawl are designed in such a way that the rotary latch can initiate a torque in the pawl and, in particular, an opening moment, wherein the torque depends on the locking position of the pawl.

2. The lock according to claim 1, wherein the rotary latch is able to initiate a first opening moment in the pawl when the pawl is fully in its detent position and that the rotary latch can initiate a second greater opening moment in the pawl, when the pawl has been partially moved out of its locking position, and when, however, the pawl prevents the rotary latch from being moved into its open position.

3. The lock according to claim 2, wherein the rotary latch and pawl are designed in such a way that the second moment is initiated in the pawl before a release lever has been pivoted by 70% and preferably by 50% for opening the locking mechanism and/or before the pawl has pivoted by 10 to 15 degrees.

4. The lock according to claim 1, wherein a tappet is provided that can move the pawl out of its locking position when the locking mechanism is opened.

5. The lock according to claim 4, wherein a tappet is arranged in such a way that it only moves the pawl out of its detent position, when the pawl is not moved out of its detent position as a result of an opening moment, that is initiated by the rotary latch in the pawl in the detent position.

6. The lock according to claim 4, wherein the tappet is arranged on a release lever and/or on an intermediate closed position pawl of the locking mechanism.

7. The lock according to claim 1, wherein the pawl and the release lever are pivotably mounted on a common axis.

8. The lock according to claim 1, comprising a blocking lever that can block the pawl in its blocked position.

9. The lock according to claim 1, wherein the release lever can move the blocking lever out of its blocking position.

10. The lock according to claim 8, comprising a spring for moving the blocking lever into its blocking position.
